(19) United States
(12) Patent Application Publication
(10) Pub. No.: US 2021/0287066 A1
(43) Pub. Date: Sep. 16, 2021

(54) PARTIAL NEURAL NETWORK WEIGHT ADAPTATION FOR UNSTABLE INPUT DISTORTIONS

(71) Applicant: HEWLETT PACKARD ENTERPRISE DEVELOPMENT LP, Houston, TX (US)

(72) Inventors: XIUFENG XIE, Palo Alto, CA (US); KYU-HAN KIM, Palo Alto, CA (US)

(21) Appl. No.: 16/817,251

(22) Filed: Mar. 12, 2020

(51) Int. Cl. G06N 3/04; G06N 20/20; G06N 5/04

(52) U.S. Cl. CPC G06N 3/0445; G06N 5/04; G06N 20/20

(57) ABSTRACT

Systems and methods are provided for an improved machine learning (ML) model system. The improved ML system can be configured to (1) initially classify the types of images and videos received by the various devices and provide the classified input to different ML models based on the classification (e.g., of the distortion level, etc.), and/or (2) reuse portions (referred to as base components) of each ML model where parameters of the base components are unchanged across the various ML models, while replacing other portions (referred to as adapted components) of the ML model where the parameters of the adapted components may change greatly.

### DESCRIPTION OF RELATED ART

Various devices, including smart cars, IoT devices, etc., capture image and video files that are transmitted via a network to a backend system for classification purposes. The images are received by machine learning (ML) models implemented at a backend system and processed. However, these images and videos may correspond with an unstable distortion level in that such types of input can be subject to, e.g., varying light intensity, image size/quality, different image formats, etc. As a result, the output provided by the backend system based on the input can provide unstable accuracy. Traditional systems are unable to solve for this unstable distortion level of the input stream, especially in view of memory consumption limitations of current computing systems.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a computer system that implements base and adaptive components for improved machine learning, in accordance with various embodiments of the disclosure.

FIG. 2 illustrates examples of fine-tuning an ML model, in accordance with various embodiments.

FIG. 3 illustrates measurements of parameters that may be chosen based components or adaptive components, in accordance with various embodiments of the disclosure.

FIG. 4 illustrates an example classification process using a trained ML model, in accordance with various embodiments of the disclosure.

FIG. 5 illustrates a computing component for determining an inference using a machine learning (ML) model.

FIG. 6 is an example computing component that may be used to implement various features of embodiments described in the present disclosure.

The figures are not exhaustive and do not limit the present disclosure to the precise form disclosed.

### DETAILED DESCRIPTION

Various machine learning (ML) models perform video analytics using pre-trained models with an assumption that inference input and training data follow the same probability distribution. However, this assumption does not always hold true. For example, autonomous vehicles may capture video with varying brightness, unstable wireless bandwidth may initiate adaptive bitrate streaming of video, and different inputs from heterogeneous internet of things (IoT) devices/cameras may be received from inference servers. In these examples, the input data may result in inaccurate inference output (e.g., object detection, segmentation, etc.). For example, if an autonomous vehicle is attempting to identify road signs or potential obstacles, but the images captured of road signs/obstacles have varying brightness, the backend system may falter in trying to categorize the road signs/obstacles because the variation in brightness results in inconsistent analysis of the same object, and pattern development is hindered. In such situations, the level of input distortion can change rapidly and reshape the probability distribution of the input.

Traditional systems may assume consistent probability distributions between the training and test dataset. Unfortunately, the inputs to ML model inference servers might have various distortions that alter the probability distribution and harm ML model performance in practice, at least because unstable inputs in image distortions (e.g., varying brightness, changing bit rates, etc.) often cause unstable outputs. Following the aforementioned scenarios, an autonomous vehicle may drive in and out of shaded areas, which can cause abrupt brightness changes in the captured video, a drone may change a compression ratio of video frames while streaming to the inference server based on wireless link bandwidth, and an edge server may process data from IoT devices with heterogeneous camera hardware and compression strategies. In these scenarios, the input distortions cover high dynamic ranges. Traditional systems may rely on an ML model with constant pre-trained weights and suffer significant accuracy loss.

One solution to process this input data is to train the ML model for each possible distortion level by augmenting the training data to match that particular distortion level (e.g., low or high brightness, low or high bit rate, etc.) and then switch between the ML models following the distortion level of the current input. However, this may be inefficient because there are enormous variances in distortion levels (e.g., a JPEG image may have 100 quality levels) and running multiple ML models concurrently may be computationally infeasible (e.g., due to memory budgeting constraints). Swapping ML models between disk and memory may also cause latency issues and thus may be impractical.

Embodiments of the present disclosure improve systems that capture input data (e.g., image and video files, etc.) using an improved machine learning (ML) model system. The improved ML system can be configured to (1) initially classify the types of images and videos received by the various devices and provide the classified input to different ML models based on the classification (e.g., of the distortion level, etc.), and/or (2) reuse portions (referred to as base components) of each ML model where parameters of the base components are unchanged across the various ML models, while replacing other portions (referred to as adapted components) of the ML model where the parameters of the adapted components may change greatly.

For example, the ML model may comprise an adaptive inference architecture that accommodates heterogeneous inputs. The ML model may implement an optimization algorithm to identify a small set of “distortion-sensitive” input parameters given a memory budget. Based on the distortion level of the input, the system may adapt only the distortion-sensitive parameters, while reusing the rest of constant parameters with the ML model. These dynamic input determinations may improve the accuracy over other ML models trained with similar undistorted datasets with increase stability training. The “distortion sensitive” parameters corresponding with the adaptive components may be adjusted to fit the distortion level of the instantaneous input, while reusing the majority of parameters corresponding with the base components across all inputs. In this way, the adaptation of parameters to various distortion levels leads to better inference accuracy, while reusing most weights guarantees the memory efficiency and scalability over conventional systems that only provide a single ML model without an adaptive inference architecture. The improved ML model enables robust inference under a broad range of input distortions, without compromising memory consumption.

In some embodiments, the system may first fine-tune the ML model to multiple versions, each with training data of a particular distortion level. Next, by comparing the original ML model and the fine-tuned versions of the ML model, the system may run an optimization problem to identify a set of distortion-sensitive weights. In some examples, the optimization may run under a constraint of additional memory budget. The identification of these distortion-sensitive weights may be performed offline.

The system may then partially fine-tune the ML model for each pre-defined distortion level, by only updating the distortion-sensitive weights (e.g., adapted parameters), while freezing the rest of the pre-trained weights (e.g., base parameters). This step yields multiple adaptors, each for a particular distortion level. The partial fine-tuning may also be performed offline.

The system may also implement a partial ML model adaptation online. With multiple fine-tuned small adaptive parameters and a single copy of the base system loaded in memory, ML model may switch between the adapted parameters, following a current input distortion level (e.g., compression level) while reusing the base parameters across all possible inputs.

The adapted components of each ML model may correspond with parameters that change greatly. For example, input may be identified as having a high distortion value (e.g., low bit rate, varying brightness, unstable wireless bandwidth transmissions, etc.). A first parameter value of a ML model may remain unchanged when comparing a first input with the high distortion value and a second input with a low distortion value, while a second parameter of the ML model may change greatly when comparing the two inputs. As such, the parameter value that remains unchanged may be considered a base component (and reused) in more than one ML model. These base components are analyzed prior to becoming base components to confirm that they are good candidates for reusing across multiple ML models and that they do not change greatly across the models.

The system provides many technical improvements over standard systems. For example, by reusing base components of various ML models, the system may conserve memory customarily used for storing these portions of resource intensive ML models. Additionally, the adapted components of the ML models can correspond with parameters that are tuned to the particular visual input received by the ML model and provide increased accuracy of the inference output determined by each ML model (e.g., object detection, segmentation, etc.).

It should be noted that the terms “optimization problem,” “optimize,” “optimal,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

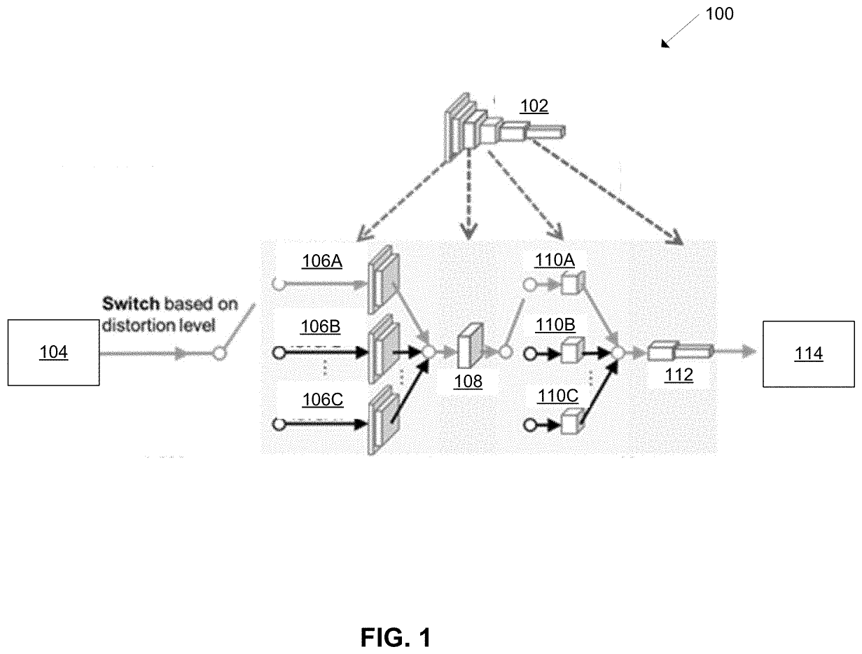

FIG. 1 is an illustrative example of the ML system, in accordance with some embodiments. In computer system 100, original ML model 102 may be separated into adaptive components 106, 110 and base components 108, 112 to receive input data 104 and determine inference data 114.

ML model 102 may correspond with various types of ML models, including a deep learning neural network (DNN) like a convolution neural network (CNN) or other artificial neural network. In some examples, each level of ML model 102 may measure the relationship between the dependent variable (e.g., classification category) and independent variables (e.g., input data, metadata, etc.) by using multiple layers of processing elements that ascertain non-linear relationships and interactions between the independent variables and the dependent variable. As a DNN, more than one layer of processing elements may exist between the input layer and output layer. As a CNN, successive layers of processing elements contain particular hierarchical patterns of connections with the previous layer.

In some examples, ML model 102 may correspond with an unsupervised learning method, such as k-nearest neighbors, to classify input data 104 based on observed similarities among the multivariate distribution densities of independent variables in a manner that may correlate with an inference to help define an object in input data 104.

In some examples, ML model 102 may correspond with linear regression. The linear regression may model the relationship between the dependent variable (e.g., classification category) and one or more independent variables (e.g., input data 104, metadata, etc.).

ML model 102 may receive input data 104. Input data 104 may comprise image or video files that are provided by one or more user devices, including personal computers, smart phones, Internet of things (IoT) devices, drones, security cameras, robots, or other user devices or computing systems that include one or more sensors for capturing images. The devices may be heterogeneous and vary greatly between the different input data sources.

Input data 104 may be transmitted from the user device to computer system 100 using electronic components for transmitting those images to ML model 102 (e.g., antenna, transmitter/receiver, etc.) via a network (e.g., Internet, closed network, short-range wireless interconnection, wired connection with an internal ML model incorporated with the device, etc.).

Input data 104 may correspond with various levels of image quality. For example the image quality may correspond with a relative quality range (e.g., high image quality, low image quality, etc.) or a threshold value (e.g., image size between 1 K and 100 K, image size between 1 meg and 100 megs, etc.). The image quality value may be embedded with the image (e.g., as metadata, etc.). As a sample illustration, low resolution images may be received from IoT devices while high resolution images may be received from self-driving cars. In some examples, the image quality may change during the transmission of the input data (e.g., streaming data that begins with a first bit rate and changes to a second bit rate in accordance with network bandwidth limitations, etc.). The origin of these images as well as the resolution level may correspond with a particular ML model.

One or more classifications may correspond with each of these levels of image quality and/or distortion levels corresponding with the images. As a sample illustration, a first classification may correspond with each relative quality range for a particular type of image and a second classification may correspond with one or more threshold values or ranges. As another sample illustration, a first classification may correspond with images received from a first camera on a single IoT device and a second classification may correspond with a different image quality on that same IoT device. In some examples, input data 104 may be compressed or otherwise adjusted from the original data settings received by a user device by computer system 100.

Input data 104 may correspond with metadata. For example, metadata of input data 104 may identify a source device, source location, file type, camera settings, time, or duration associated with input data 104. In some examples, input data 104 may include additional metadata, including keywords, tags, descriptions, comments, or other user generated information, or information specifically limited to video input data 104, including a transcript of speech provided with the video, bit rate, or other video settings.

In some examples, input data 104 may correspond with multiple IOT devices that provide corresponding input data 104 or a single IOT device having multiple sensors that provides corresponding input data 104. In some examples, the device may be configured to generate adaptive input content that can change the composition of the input data based on various factors, including network bandwidth or image quality. As example illustration, the adaptive computing device may record a video of high quality and transmit the video at a lower quality to correspond with the network bandwidth.

In some examples, each of these different types of input data 104 may correspond with different ML models, such that each different ML model is tuned to the type of input data it receives. For example, a first ML model may correspond with input data that exceeds a value of brightness in the image that originates from a first type of user device, the second ML model may correspond with input data that is less than the value of brightness for the image, and a third ML model may correspond with any image received from a particular user device that produces image data using a particular software application.

Each ML model 102 that corresponds with the particular input data may comprise one or more adaptive component 106 (illustrated as adaptive component 106A, adaptive component 106B, and adaptive component 106C) and adaptive component 110 (illustrated as adaptive component 110A, adaptive component 110B, and adaptive component 110C), and one or more base components 108, 112.

Adaptive components 106, 110 may comprise portions of ML model 102 that change or are affected by the particular input received. The model parameters vary across different ML models in adaptive components 106, 110. Base components 108, 112 may comprise portions of ML model 102 that remain the same or are minimally affected by the particular input received. The model parameters remain the same across different ML models in base components 108, 112. During a training or partial training process of ML model 102, parameters corresponding with adaptive components 106, 110 may be run through the training process while parameters corresponding with base components 108, 112 may be frozen and reused from earlier training processes. The various depictions of adaptive component 106A, adaptive component 106B, adaptive component 106C, adaptive component 110A, adaptive component 110B, and adaptive component 110C may identify the different parameters corresponding with each adaptive component defined by the different ML models.

When viewing base components 108, 112 and adaptive components 106, 110, the number of base components may significantly outweigh the number of adaptive components. The parameters that correspond with the base components may remain the same across several ML models because, for example, each of the input data received may be image or video data with similar parameters used to determine inference output 114. Since the input data received are similar types of data, parameters used in the ML models may remain the same and, thus correspond with the same parameters defined with base components 108, 112. In another sample illustration, the brightness value in a single video input data may change corresponding to a value sequence of 1, 2, 3, 4, 5; 1, 2, 3, 4, 5. The corresponding ML model parameter may change in the same way to reach that different quality value. As such, the brightness parameter value may be included with an adaptive component (e.g., changing within the video), whereas the video file type originating from the single video may be included with a base component (e.g., unchanged).

ML model 102 may be trained. In some examples, ML model 102 may be trained by using distorted training data. For example, since human eyes are insensitive to the high-frequency components of the visual input, encoders like JPEG and H.264 distort such high-frequency components in a spatial-frequency domain. Similarly, after reducing the image brightness, human eyes may still perceive object outlines (e.g., low-frequency components), but not textures (e.g., high-frequency components). In some examples, visual distortions in practice may add noise to the high-frequency components, which may be similar to various image compression processes. Public data sets may be used to supplement the training process.

Various distortion and/or compression methods may be used with the training process. For example, the distortion may comprise resolution scaling, where a video resolution may be compressed from an original resolution to a smaller resolution using an encoder (e.g., H.264 encoder, etc.) at a constant rate factor (CRF) with small quantization loss. In another example, the distortion may comprise image compression (e.g., JPEG compression, etc.). In another example, the distortion may adjust image relative brightness of the image to a brighter or darker value as the original data set. The brightness may be adjusted to correspond with a predetermined brightness value so that the adjusted brightness may correspond with a range of values (e.g., 10% of the original brightness, double the original brightness, etc.) with the resolution unchanged.

In some examples, portions of ML model 102 may be measured to determine if the portion of ML model 102 should be an adaptive component or remain a base component of the system. For example, a frequency response from a gradient-based ML model sensitivity modeling technique may be compared with a similar portion of ML model for both the original ML model and the fine-tuned ML model with distorted training data. Backward propagation may be performed to obtain the gradient of the loss with respect to at least some of the Discrete Fourier Transform (DCT) coefficients in input data 104. A higher gradient amplitude at a certain frequency band may indicate that either original ML model or gradient-based ML model is more sensitive to signal on this band.

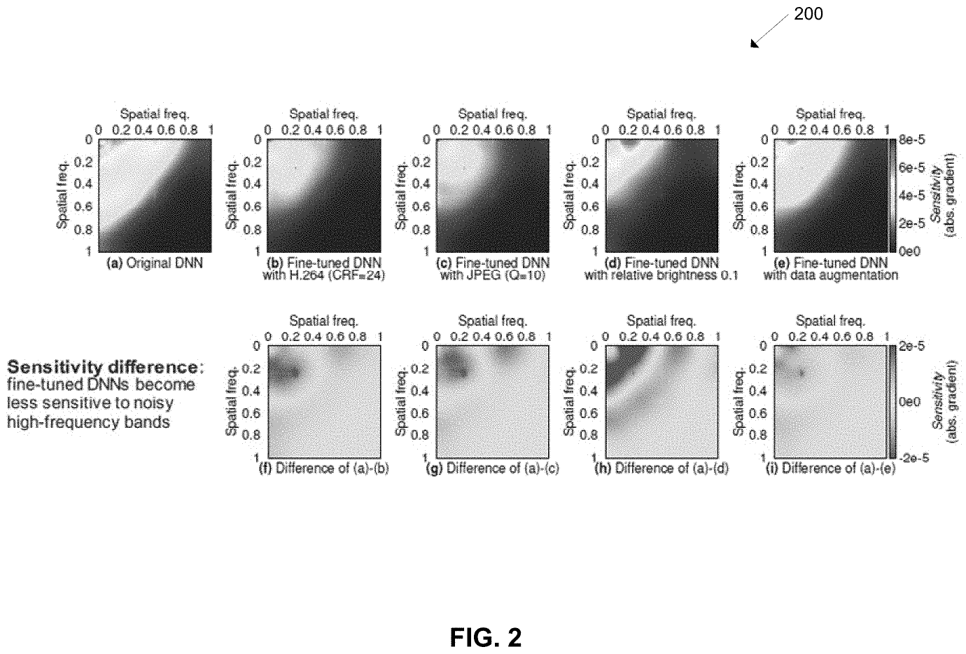

FIG. 2 illustrates examples of fine-tuning an ML model, in accordance with various embodiments. For example, fine-tuning examples 200 can reshape the ML model's frequency response and help the ML model avoid looking at a noisy spectrum. For example, fine-tuning examples 200 may include (i) H.264 compression with a quality (CRF) of 24; (ii) JPEG compression with a quality of 10; (iii) Underexposure with 10% brightness of the original image; (iv) Data augmentation that mixes frames with different H.264 qualities with CRF from 15 to 24 in one training set. ML model 102 frequency responses are provided as well. Compared to the original ML model, the fine-tuned ML model may become less sensitive to the high-frequency components. Since distortions may be similar to adding noise to the high-frequency bands, the fine-tuned ML model may learn to avoid programmatically relying on the noisy high-frequency bands for better robustness. These sample illustrations of the distortions are provided for illustrative purposes only, and should in no way limit the disclosure herein.

Returning to FIG. 1, the trained ML model may be analyzed to determine which components of the model should be adaptive components and which components of the model should be base components. For example, the system may first fine-tune a pre-trained ML model by using distorted training datasets and compare the resulting weights with the original ML model. During this process, the system may let K denote the number of layers in D, and Iᵢ denote each layer, which contains Nᵢ weights, then Iᵢ={p¹ᵢ, p²ᵢ, . . . p^{N j}ᵢ}. The system may let p^{j}ᵢ denote the j-th weight of the layer Iᵢ in the original pre-trained ML model, and f_{q}(·) denote the fine-tuning process with a certain distortion level q, then f_{q}(p^{j}ᵢ) is the corresponding weight of the fine-tuned ML model. The average change of weight values in layer Iᵢ, caused by fine-tuning, can be computed as:

$${v}_{i}^{q} = \frac{1}{{N}_{i}} {\sum }_{j = 1}^{{N}_{i}} ‖ {p}_{i}^{j} - {f}_{q} ( {p}_{i}^{j} ) ‖ \qquad ( 1 )$$

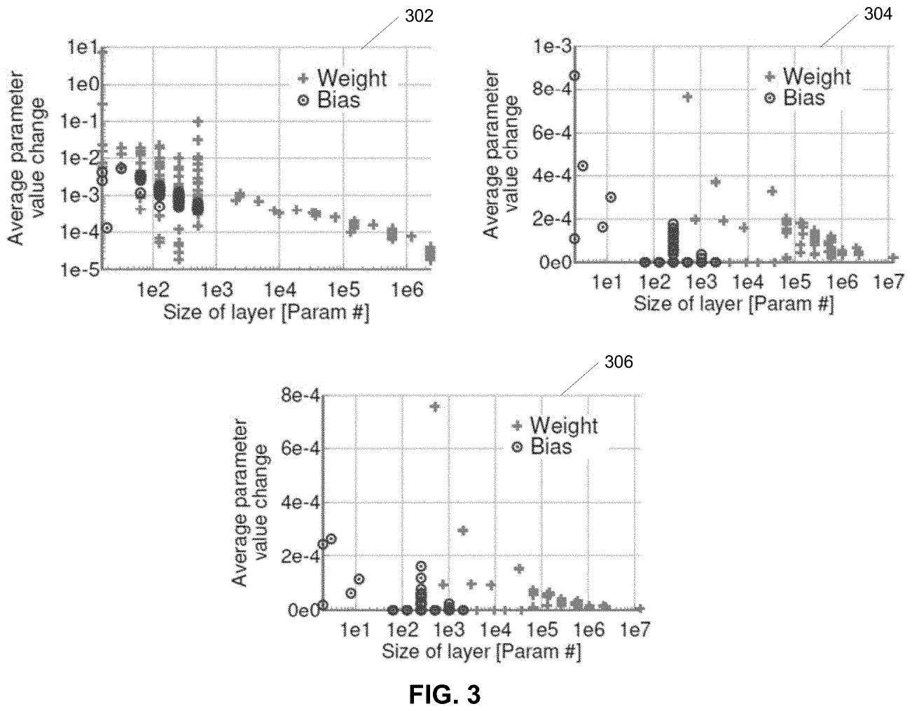

Illustrative output of this equation (1) is provided with FIG. 3. For example, the layers with a high v^{q} value yield significant change of weight values, when fine-tuned to fit the distortion level q, which means they are sensitive to the distortion level. Therefore, v^{q} as the distortion sensitivity of layer Iⱼ. Conceptually, this equation may help explain the intuition that some parameters may be more important than other parameters when the values of the input data are different, or that only a small fraction of the parameters may change significantly with the front types of input data (e.g., high brightness and low brightness in image input data may affect certain parameters whereas low-volume in video input data may affect other parameters, etc.).

Following equation (1), the layer-level weight change caused by the fine-tuning for the three illustrated cases may be measured as: DRN-D-38 fine-tuned with H.264 of quality level (CRF) 23 in illustration 302; Mask R-CNN fine-tuned with JPEG of quality level (Q) 10 in illustration 304; and, Mask R-CNN fine-tuned with dimmed images of relative brightness 0.2 in illustration 306.

In illustration 302, the sum size of the DRN “weights” (including both the weights and biases) that changed more than 2×10⁻⁴ after fine-tuning only accounts for 1.44% of the model size. Similarly, only 0.08% and 0.0058% of the Mask R-CNN weights changed more than 2×10⁻⁴ in illustration 304 and illustration 306. When reviewing the output of the formula, only a tiny portion of ML model weights have non-negligible changes (e.g., >2 10⁻⁴) after fine-tuning with distorted data. In order to fit ML model to the distorted inputs, computer system 100 can reshape the frequency response of a ML model by changing such a tiny portion of ML model weights for ML model 102.

Since only a portion of ML model weights have non-negligible changes after fine-tuning with distorted data, computer system 100 may select and fine-tune only “distortion-sensitive” weights. In some embodiments, this can be formulated as a knapsack problem, where the “item weight” of layer Iᵢ is its parameter number Nᵢ, while the “item value” of Iᵢ is its distortion sensitivity defined in Equation (1). Computer system 100 may select a list S of ML model layers to maximize the total “value” (distortion sensitivity) v^{q}, under the constraint that the total “size” (memory consumption) Nᵢ is within M, which is summarized in Equation (2).

$${max}_{S} {\sum }_{i ∈ S} {v}_{i}^{q} \\ s . t . {\sum }_{i ∈ S} {N}_{i} \leq M \qquad ( 2 )$$

After obtaining the optimal list of layers S, the corresponding ML model portion A={Iᵢ: i∈S} (e.g., the adaptive components) may be fine-tuned with the dataset of quality q while keeping the rest of the ML model portions (e.g., the base components, or B=D \ A) constant or frozen. This step can be denoted as A^{q}=f_{q}(A).

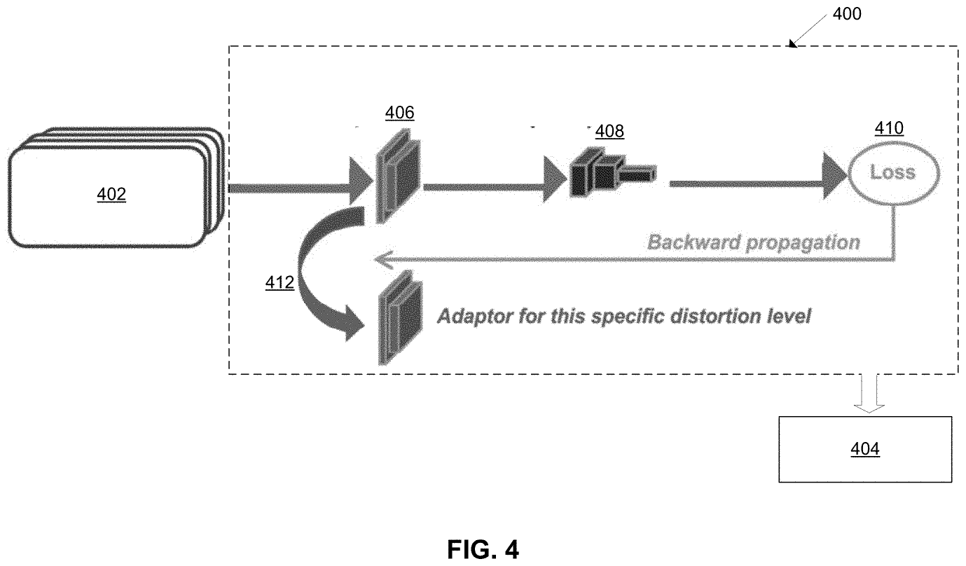

Once the ML model is trained and the adaptive components and base components are selected, computer system 100 may receive input data 402 to classify, as shown with FIG. 4. In the illustrated example, input data 402 are received from a particular user device, like a camera integrated with a smart car and the like. Input data 402 may be transmitted via a network to computer system 400 for classification purposes. Input data 402 may be analyzed for one or more classifications by computer system 400, including the originating device (e.g., model of smart device, etc.), type of input (e.g., JPG, MP4, etc.), or other information that may classify the input received. The identified classification may correspond with a particular ML model that has been trained in accordance with input corresponding with the identified classification (e.g., a first ML model for high quality images, a second ML model for low light video, etc.). Upon providing input data 402 to the particular ML model, the ML model may provide inference output 404 (e.g., object detection, segmentation, phonetic classification, hand-writing recognition, etc.).

Computer system 400 may implement adaptive components 406 and base components 408 with the ML model. The ML model may correspond with a robust inference architecture that adapts only a small portion of the ML model, following the instantaneous input distortion. Computer system 400 may implement a partial ML model adaptation online. With multiple fine-tuned small adaptive parameters and a single copy of the base system loaded in memory, ML model may switch between the adapted parameters, following a current input distortion level (e.g., compression level) while reusing the base parameters across all possible inputs.

In some embodiments, the first step of ML model is to split the weights into two sets, including adaptive components 406 that change in real-time to fit the current input distortion level and base components 408 that remain constant for all possible input qualities. Backward propagation may be performed to obtain the gradient of loss 410 with respect to at least some of the Discrete Fourier Transform (DCT) coefficients in input data 402. A higher gradient amplitude at a certain frequency band may indicate that either original ML model or gradient-based ML model is more sensitive to signal on this band. The ML model fine-tunes 412 the entire neural network with distorted data and compares it with the original one, to obtain the distortion-sensitivity metric v^{q}. Then, by solving the optimization problem in Equation (2), the ML model obtains a subset of layers to fine-tune 412.

In some embodiments, the ML model fine-tunes 412 adaptive components 406, each with a dataset of a particular distortion level, while freezing the rest of the weights and base components 408, as illustrated in FIG. 4. In this way, ML model obtains multiple fine-tuned adaptors, each fitting a particular input distortion level. This process may also correspond with partial training when particular parameters are identified as not changing more than a threshold value, so that the training process freezes those parameters (e.g., base parameters/components, etc.) and only trains the remaining parameters corresponding with adaptive components.

With the fine-tuned adaptive components 406 and base components 408, the ML model may be run online. In some examples, the memory size to store the components may be relatively small so that an inference server can load multiple adaptors for all supported distorted levels at a low memory cost. Next, given a visual input stream with various distortion levels (e.g., adaptive bit rate (ABR) streaming or receiving from heterogeneous IoT hardware), ML model may switch between adaptive components 406 to fit the instantaneous input distortion levels, while keeping the base components 408 unchanged.

As sample illustrations, for JPEG images, the quality level can be directly embedded in the image. For Dynamic Adaptive Streaming over HTTP (DASH) video streaming, the frame resolution may be provided with the video (e.g., in metadata). For various other file types, brightness levels may be computed by computer system 400 by determining the brightness level of one or more pixel values and computing an average of the overall image. Based on these values, either provided with the image or computed by computer system 400, adaptive components 406 may be chosen to correspond with these values. Overall, it is simple and fast to determine which adaptor to use for the current input frame, enabling the real-time adaptation.

For adapting a subset of weights in ML model of computer system 400, the positions in the model may also be determined in addition to the values. For example, computer system 400 may implement layer level adaptation by using value range (e.g., 0-1) vector to mark weights for adaptation (e.g., 0 means no adaption and 1 means otherwise).

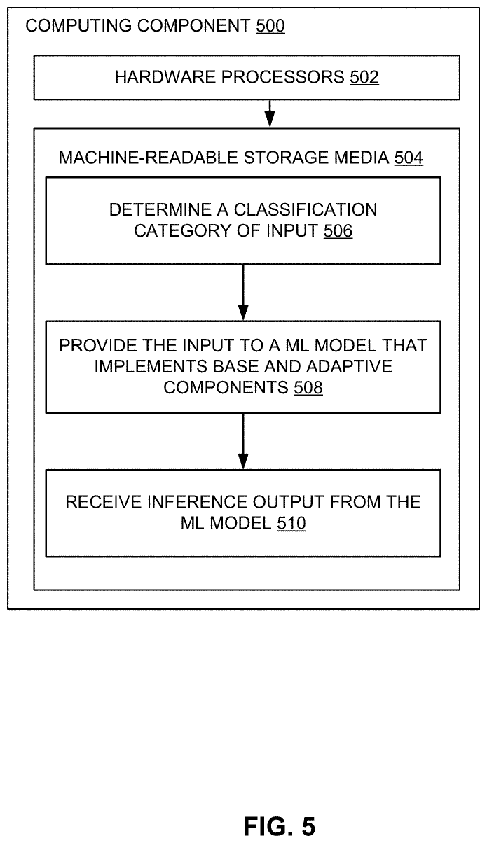

FIG. 5 illustrates an example iterative process performed by a computing component 500 for providing input and receiving inference output from a trained ML model that implements base and adaptive components. Computing component 500 may be, for example, a server computer, a controller, or any other similar computing component capable of processing data. In the example implementation of FIG. 5, the computing component 500 includes a hardware processor 502, and machine-readable storage medium 504. In some embodiments, computing component 500 may be an embodiment of a system corresponding with computer system 100 of FIG. 1.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-510, to control processes or operations for optimizing the system during run-time. As an alternative or in addition to retrieving and executing instructions, hardware processor 502 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-510.

Hardware processor 502 may execute instruction 506 to determine a classification category of input data. For example, the classification category may be determined as being associated with metadata of input content.

Hardware processor 502 may execute instruction 508 to provide input to a machine learning (ML) model that implements base and adaptive components. For example, the input content may be provided to a ML model of a set of ML models. The ML model may correspond with a classification category associated with metadata of the input content. The set of ML models may correspond with different classification categories than the classification category associated with the metadata. The set of ML models may share at least one base component that is reused among at least some of the set of ML models. The set of ML models may not share at least one adaptive component that differs among the set of ML models.

Hardware processor 502 may execute instruction 510 to receive inference output from the ML model. For example, the inference output from the ML model may correspond with the input content. As an illustrative example, the inference output can correspond with object detection in images or video, phonetic classification of audio input, or segmentation of visual input.

In some examples, hardware processor 502 may execute an instruction to receive input content from a user device and provide inference output to the same user device. In some examples, the classification category may correspond with the type of user device (e.g., brand, model, functionality, network communication protocol, etc.). In some examples, the classification category may correspond with an application and incorporated with the user device (e.g., operating system, communication application, entertainment application, etc.).

In some examples, hardware processor 502 may execute an instruction to determine the classification category based on the input content. The classification category may correspond with a bit rate of input content when compared to a threshold value (e.g., 50%, etc.).

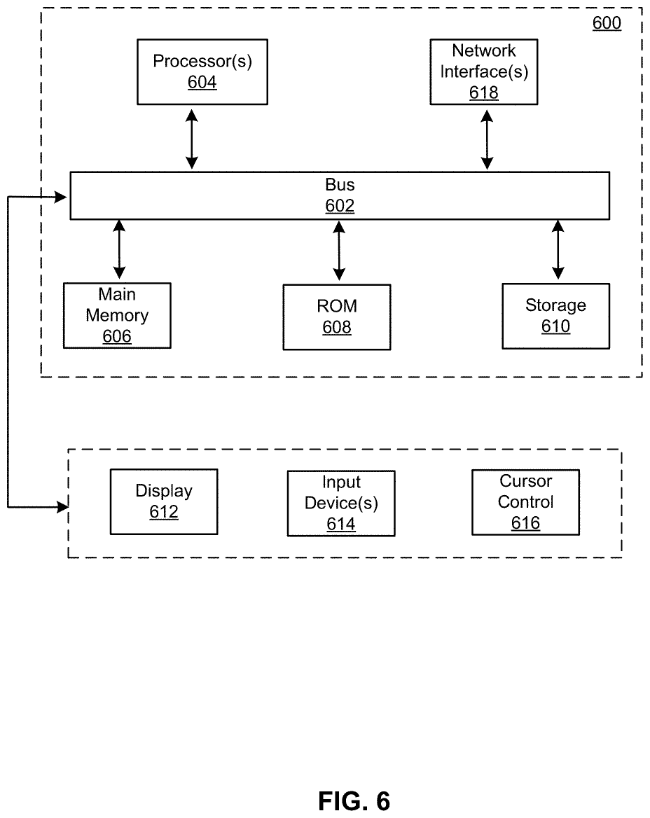

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method for determining an inference, the method comprising:
determine a classification category associated with metadata of input content;
provide the input content to a machine learning (ML) model of a set of ML models, wherein the ML model corresponds with the classification category associated with the metadata of the input content, wherein the set of ML models correspond with different classification categories than the classification category associated with the metadata, and wherein the set of ML models share at least one base component that is reused among at least some of the set of ML models and do not share at least one adaptive component that differs among the set of ML models; and
receive an inference output from the ML model, wherein the inference output corresponds with the input content.

2. The computer-implemented method of claim 1, wherein the input content is received from a user device and the inference output is provided to the user device.

3. The computer-implemented method of claim 2, wherein the classification category corresponds with a type of the user device.

4. The computer-implemented method of claim 2, wherein the classification category corresponds with an application incorporated with the user device.

5. The computer-implemented method of claim 1, wherein the classification category corresponds with a bit rate of the input content when compared to a threshold value.

6. A computer system for determining an inference, the computer system comprising:
a memory; and
one or more processors that are configured to execute machine readable instructions stored in the memory for performing the method comprising:
determine a classification category associated with metadata of input content;
provide the input content to a machine learning (ML) model of a set of ML models, wherein the ML model corresponds with the classification category associated with the metadata of the input content, wherein the set of ML models correspond with different classification categories than the classification category associated with the metadata, and wherein the set of ML models share at least one base component that is reused among at least some of the set of ML models and do not share at least one adaptive component that differs among the set of ML models; and
receive an inference output from the ML model, wherein the inference output corresponds with the input content.

7. The computer system of claim 6, wherein the input content is received from a user device and the inference output is provided to the user device.

8. The computer system of claim 7, wherein the classification category corresponds with a type of the user device.

9. The computer system of claim 7, wherein the classification category corresponds with an application incorporated with the user device.

10. The computer system of claim 6, wherein the classification category corresponds with a bit rate of the input content when compared to a threshold value.

11. A non-transitory computer-readable storage medium storing a plurality of instructions executable by one or more processors, the plurality of instructions when executed by the one or more processors cause the one or more processors to:
determine a classification category associated with metadata of input content;
provide the input content to a machine learning (ML) model of a set of ML models, wherein the ML model corresponds with the classification category associated with the metadata of the input content, wherein the set of ML models correspond with different classification categories than the classification category associated with the metadata, and wherein the set of ML models share at least one base component that is reused among at least some of the set of ML models and do not share at least one adaptive component that differs among the set of ML models; and
receive an inference output from the ML model, wherein the inference output corresponds with the input content.

12. The computer-readable storage medium of claim 11, wherein the input content is received from a user device and the inference output is provided to the user device.

13. The computer-readable storage medium of claim 12, wherein the classification category corresponds with a type of the user device.

14. The computer-readable storage medium of claim 12, wherein the classification category corresponds with an application incorporated with the user device.

15. The computer-readable storage medium of claim 11, wherein the classification category corresponds with a bit rate of the input content when compared to a threshold value.
